(19) United States
(12) Patent Application Publication
(10) Pub. No.: US 2006/0114787 A1
(43) Pub. Date: Jun. 1, 2006

(54) Simultaneous playback and persistent storage of digital media content

(76) Inventors: Yann Festal, Del Mar, CA (US); Jerome Poichet, San Diego, CA (US)

Correspondence Address: FISH & RICHARDSON, PC, P.O. BOX 1022, MINNEAPOLIS, MN, 55440-1022, US

(21) Appl. No.: 11/000,594

(22) Filed: Nov. 30, 2004

(51) Int. Cl. G11B 5/09

(52) U.S. Cl. 369/59.1; 369/47.1

(57) ABSTRACT

Simultaneous playback and storage of digital media content is described. In one aspect, digital media content is stored by reading a first portion of the digital media content from a content storage and, while reading the first portion of the digital media content from the content storage, copying the first portion of the digital media content to an image file. In addition, the first portion of the digital media content is passed from the content storage to a receiving device, and a map file is updated to indicate that the first portion of the digital media content has been copied to the image file.

### TECHNICAL FIELD

This description relates to methods and systems for the storage and playback of digital media.

### BACKGROUND

Digital media content is typically stored and played back from a removable digital media, such as a DVD, in the case of video, or a compact disk, in the case of audio. It is often desired to backup or archive this digital media, such as by storing it all on a personal computer or other playback device so that it can be accessed more easily. When this is done, the digital media is first copied to a personal computer. Once it is copied in its entirety, it can be played back through a separate application such as Microsoft's Windows Media Player or Apple's Quicktime Player.

### SUMMARY

In one aspect, digital media content is stored by reading a first portion of the digital media content from a content storage and, while reading the first portion of the digital media content from the content storage, it is simultaneously copied to a persistent image file. In addition, the first portion of the digital media content is passed from the content storage to a receiving device, and a map file is updated to indicate the contents of the image file. These and other features and embodiments of the invention are described in the detailed description, figures, and claims that follow.

### DESCRIPTION OF DRAWINGS

FIG. 1 shows an illustrative media system.

FIG. 2 illustrates data flow in a system that plays DVDs.

FIG. 3 illustrates data flow in a media system that stores content during playback of that content.

FIGS. 4a, 4b, and 4c illustrate the contents of an image file and a map file during certain operations.

FIGS. 5a-g further illustrate the contents of an image file and a map file during certain operations.

Like reference symbols in the various drawings indicate like elements.

### DETAILED DESCRIPTION OF PREFERRED EMBODIMENTS

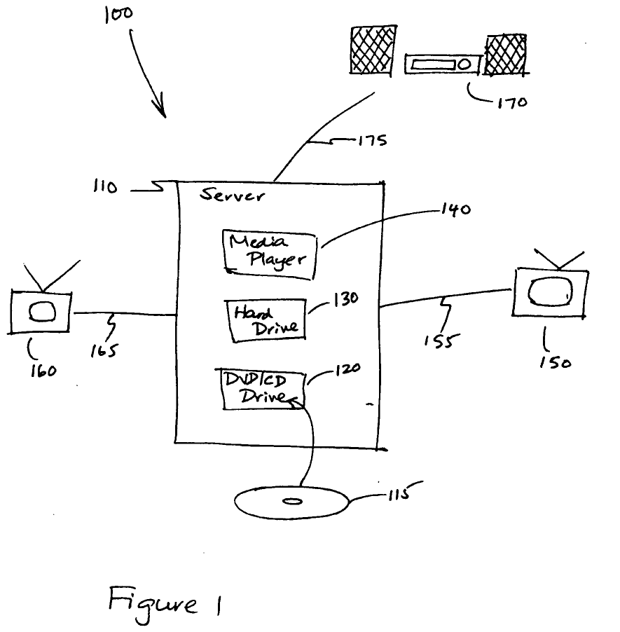

FIG. 1 shows a media system 100 including a server 110. The server 110 comprises a DVD drive 120, a hard drive 130, and a media player 140, which are communicatively coupled together. The server 110 may communicate via communication connections 155, 165, and 175 with devices such as televisions 150 and 160 and audio system 170, respectively. The communication connections 155, 165, and 175 may be wired, wireless, or any other mode of communication. Televisions 150 and 160, audio system 170, and server 110, may be located in the same room, in different rooms, or in different buildings.

In an embodiment, server 110 has multiple hard drives 130 in an array constituting as much as 10 terabytes (TB) of storage capacity. A content storage medium, such as a DVD 115, is placed in the media drive 120 (e.g. a DVD drive) and content from DVD 115 is stored on hard drive 130. Media player 140 is used to play this content on one or more televisions 150 and 160, and audio systems 170. In a presently preferred embodiment, media player 140 plays the content at the same time that the content is being persistently stored onto hard drive 130 from DVD 115 for later playback. Media player 140 can play the content directly from the hard drive 130 at a later time, without the need of the DVD 115. Also, media player 140 can play different content on each device (televisions 150 and 160 and audio system 170), the same content on each device, or any combination thereof.

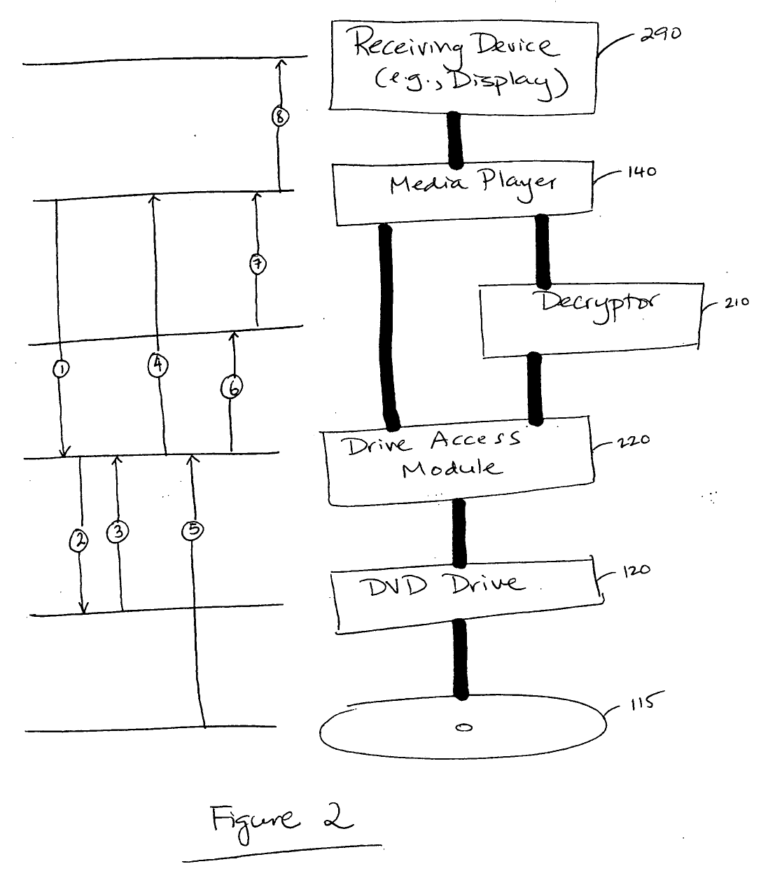

FIG. 2 illustrates data flow in a system that plays DVDs. Media player 140 reads data from DVD 115 by sending drive access requests to drive access module 220, which passes the requests on to the DVD drive 120, which then accesses DVD 115. The first attempted access of DVD 115 by media player 140 initiates an authentication protocol between DVD drive 120 and media player 140. As with all data flow to and from DVD drive 120, the authentication protocol passes through drive access module 220.

Once authentication is complete, data stored on DVD 115 may be retrieved. DVD drive 120 reads data from DVD 115 and passes it to drive access module 220. If the data is encrypted, drive access module 220 may send the encrypted data to a decryptor 210, which decrypts the data and then passes it to media player 140 for playback. If the content is not encrypted, drive access module 220 may pass the content directly to media player 140. In either case, media player 140 may send decrypted data to a receiving device 290, such as television 150 or a video recorder.

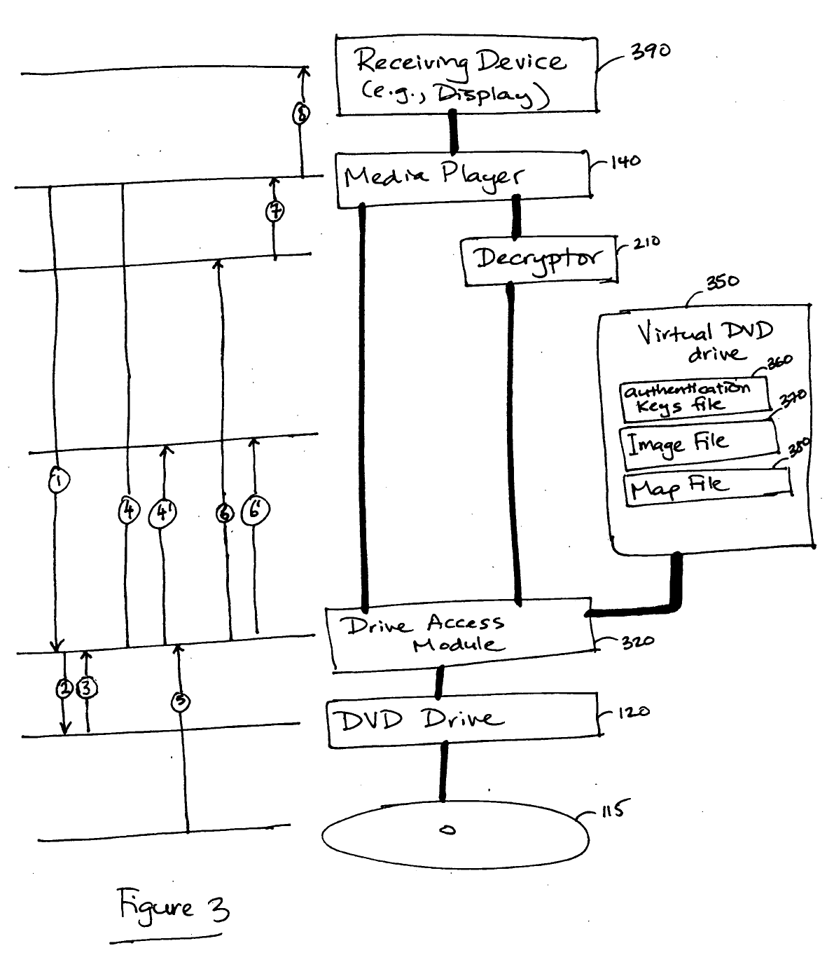

FIG. 3 illustrates data flow in a media system that simultaneously, and persistently, stores content during playback. Reference numerals are shown in FIG. 3 to assist in understanding the data flow.

Media player 140 reads data from DVD 115 by sending (1) a drive access request to drive access module 320. The drive access module 320 passes the request on to the DVD drive 120, which will in turn access DVD 115. However, on the first attempted access of DVD 115 by media player 140, an authentication protocol is initialized (2) between DVD drive 120 and media player 140. The authentication protocol passes through drive access module 320. Authentication data is sent (3) from the DVD drive 120 to the media player 140. As the authentication data passes through drive access module 320 en route (4) to the media player 140, the drive access module 320 stores (4′) a copy of the authentication keys in an authentication keys file 360 within a virtual DVD drive 350. (Virtual DVD drive 350 is preferably persistent storage, such as hard drives 130.)

Once authentication is complete, data stored on DVD 115 may be retrieved. DVD drive 120 reads data from DVD 115 and sends (5) it to drive access module 320. As the data is received by drive access module 320, and while it is being forwarded (6) on, for example to decryptor 210, a copy is stored (6′) in image file 370 in virtual DVD drive 350. When the data is stored, the map file 380 is updated to identify where the data was stored in the image file and how large it is.

If the data retrieved from the DVD 115 is encrypted, the drive access module 320 passes the encrypted data to a decryptor 210. The decryptor 210 will decrypt the data and, in turn, send (7) the decrypted data to media player 140 for playback (8). If the content is not encrypted, drive access module 220 passes the content directly to media player 140. In either case, media player 140 may send decrypted data to a receiving device 390, such as television 150 or a video recorder.

After the data from DVD 115 has been stored in image file 370 in virtual DVD drive 350, the user of the media system 100 can play the stored content from the virtual DVD drive 350 at a later time (in addition to the playback while the content is being copied). In an embodiment, media player 140 may access virtual DVD drive 350 to retrieve the content from image file 370. In an embodiment, media player 140 may be unable to detect that the content is being played from virtual DVD drive 350 rather than directly from DVD 115. Thus, it is possible to play digital content (e.g. a DVD 115) from the digital content drive (e.g., DVD drive 120), simultaneously copy the digital content to a virtual drive (e.g., virtual DVD drive 350), and further simultaneously effect the playback of the digital content from the virtual drive (rather than from the DVD 115) on a media player 140 with no perceptible difference to a viewer.

According to a presently preferred embodiment, drive access module 320 is implemented by adding to the functionality of four standard operations (open, close, read and seek) associated with it. Thus, instead of just sending control signals/commands to the DVD drive 120, it can send control signals to the virtual DVD drive too. The open operation is modified to open image file 370 and initiate map file 380. The close operation is modified to close image file 370 and write map file 380. The read operation is modified to write retrieved data into image file 370 and update map file 380. The seek operation is modified to update the current position in image file 370.

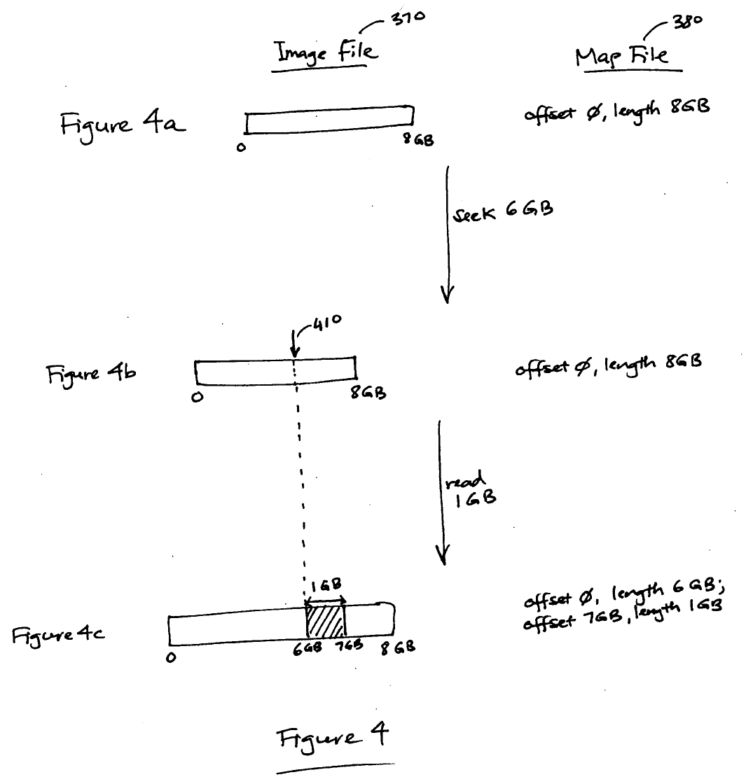

FIG. 4 illustrates an example of this functionality. We begin with reference to the virtual DVD drive 350 while the media player 140 is attempting to access the DVD 115.

In FIG. 4a, image file 370 has length 8 gigabytes (GB) and has no data (unshaded portions represent no data). Map file 380 is a data structure identifying the portions of image file 370 which have no data; thus in FIG. 4a, map file 380 lists the entire file (offset 0, length 8 GB).

In FIG. 4b, a seek operation has been executed to offset 6 GB. Pointer 410, which represents the current position in image file 370, is updated to point to offset 6 GB. No changes have been made to image file 370, so no changes are made to map file 380.

In FIG. 4c, a read operation has been executed to read 1 GB starting at the current position. This data is copied from the DVD 115 to the corresponding location in image file 370. Because image file 370 has changed, map file 380 is updated to list only the portions of image file 370 that are currently empty (offset 0, length 6 GB; offset 7 GB, length 1 GB).

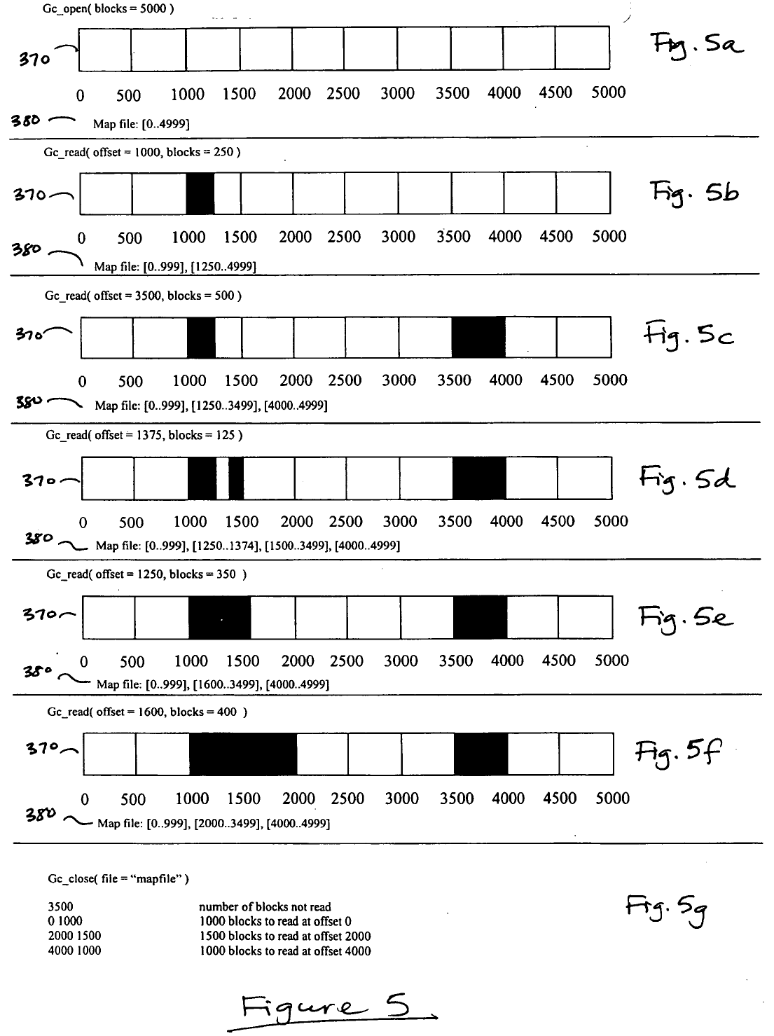

As another example, FIG. 5 (FIGS. 5a-g) illustrates the contents of image file 370 and map file 380 upon several accesses to DVD 115. In FIG. 5a, an open command causes image file 370 to be opened and map file 380 to be initiated. In FIGS. 5b-f, read commands result in copying of the data read from DVD 115 to image file 370 and updating of map file 380. FIG. 5g interprets the final contents of map file 380.

A number of embodiments of the invention have been described. Nevertheless, it will be understood that various modifications may be made without departing from the spirit and scope of the invention. For example, data flow between modules or devices may not be direct; instead it may pass through buffers, caches, or other modules or devices. Media server 110 may use the Linux operating system or another operating system. Drive access module 320 may be implemented in Linux by modifying a low-level C library, such as libc6 or glibc, which may include system-wide implementations of the modified open, close, read, and seek commands. In addition, map file 380 may represent locations within image file 370 that hold valid data. Further, map file 380 may be implemented as metadata in the header of image file 370. An encryption key used by decryptor 210 may be stored, in either encrypted or decrypted form, in image file 370 itself. Alternatively, an encryption key may be stored in a separate file within virtual DVD drive 350. Also, the digital content may be stored on a variety of content storage media, including, but not limited to, CD, DVD, blue ray DVD, and audio DVD.

Furthermore, a software agent can be resident on the server 110 that prompts the user to select from a series of menu commands. These menus can reflect the contents of the various media drives or units connect to the server, and in particular the virtual DVD drive 350. Thus, when selections are made from the menu, for instance to play a movie in the media drive, the software agent can check to see whether the particular movie is archived in the library and prompt the user as to whether a copy can or should be made on the virtual DVD drive. Likewise, a selection of a digital media content that is only on the virtual DVD drive can truncate the functionality of the drive access unit so that no commands are sent to other connected media players in a manner that might disrupt system performance.

What is claimed is:

1. A method for storing digital media content comprising:
reading a first portion of the digital media content from a content storage;
passing the first portion of the digital media content from the content storage to a receiving device;
while passing the first portion of the digital media content to the receiving device, copying the first portion of the digital media content to a persistent image file;
updating a map file to indicate that the first portion of the digital media content has been copied to the image file.

2. The method of claim 1, wherein the receiving device is a digital media player, further comprising playing the first portion of the digital media content in the digital media player.

3. The method of claim 2, further comprising:
reading a second portion of the digital media content from the content storage; and
copying the second portion of the digital media content to the image file;
wherein said playing the first portion begins before said reading a second portion; and
wherein said playing the first portion begins before said copying the second portion.

4. The method of claim 1, wherein the map file indicates which portions of the digital media content have been copied to the image file.

5. The method of claim 1, wherein the map file indicates which portions of the digital media content have not been copied to the image file.

6. The method of claim 1, further comprising:
reading an encryption key from the content storage; and
storing the encryption key with the image file.

7. The method of claim 1, wherein the image file comprises all the digital media content stored on the content storage, further comprising:
reading the first portion of the digital media content from the image file; and
playing the first portion of the digital media content in a digital media player.

8. An article comprising computer instructions for storing digital media content, the instructions operative to cause one or more processors to:
read a first portion of the digital media content from a content storage;
while reading the first portion of the digital media content from the content storage, copy the first portion of the digital media content to a persistent image file;
pass the first portion of the digital media content from the content storage to a receiving device;
update a map file to indicate that the first portion of the digital media content has been copied to the image file.

9. The article of claim 8, wherein the receiving device is a digital media player, and wherein the instructions are further operative to cause the first portion of the digital media content to be processed by the receiving device.

10. The article of claim 9, wherein the instructions are further operative to:
read a second portion of the digital media content from the content storage;
copy the second portion of the digital media content to the image file;
process the first portion in the receiving device before said reading of the second portion; and
process the first portion before said copying of the second portion.

11. The article of claim 8, wherein the map file indicates which portions of the digital media content have been copied to the image file.

12. The article of claim 8, wherein the map file indicates which portions of the digital media content have not been copied to the image file.

13. The article of claim 8, wherein the instructions are further operative to:
read an encryption key from the content storage; and
store the encryption key with the image file.

14. The article of claim 8, wherein the image file comprises all the digital media content stored on the content storage, and wherein the instructions are further operative to:
read the first portion of the digital media content from the image file; and
play the first portion of the digital media content in a digital media player.

15. A computer-implemented system for storing digital media content comprising:
a drive access module configured to read a first portion of digital media content from a removable digital media storage;
a content backup module, communicatively coupled to the drive access module, configured to copy the first portion of the digital media content to a persistent image file while the drive access module causes the first portion of the digital media content from the content storage to be sent to a media player, and further configured to update a map file indicative that the first portion of the digital media content copied to the image file; and
a digital media player, communicatively coupled to the drive access module, configured to receive and process the first portion of the digital media content from the content storage.

16. The system of claim 15, wherein:
the drive access module is further configured to read a second portion of the digital media content from the content storage;
the content backup module is further configured to copy the second portion of the digital media content to the image file;
the digital media player is configured to play the first portion before the content access module reads the second portion; and
the digital media player is configured to play the first portion before the content backup module copies the second portion.

17. The system of claim 15, wherein the map file indicates which portions of the digital media content have been copied to the image file.

18. The system of claim 15, wherein the map file indicates which portions of the digital media content have not been copied to the image file.

19. The system of claim 15, wherein:
the drive access module is further configured to read an encryption key from the content storage; and
the content backup module is further configured to store the encryption key with the image file.
